(19) United States
(12) Patent Application Publication
(10) Pub. No.: US 2026/0035025 A1
(43) Pub. Date: Feb. 5, 2026

(54) CARTS WITH GUIDE WHEELS

(71) Applicant: Cannon Equipment LLC, Cannon Falls, MN (US)

(72) Inventor: Sean Paul Grainger, Woodbury, MN (US)

(73) Assignee: Cannon Equipment LLC, Cannon Falls, MN (US)

(21) Appl. No.: 19/223,921

(22) Filed: May 30, 2025

Related U.S. Application Data
(60) Provisional application No. 63/678,623, filed on Aug. 2, 2024.

(51) Int. Cl. B62B 3/02; B62B 3/00

(52) U.S. Cl. CPC B62B 3/02; B62B 3/008; B62B 3/002; B62B 2301/08; B62B 2301/10

(57) ABSTRACT

A cart for transporting objects includes a frame longitudinally extending between a first end and a second end and a plurality of wheel assemblies and a guide wheel coupled to the frame. The plurality of wheel assemblies and the guide wheel are configured to facilitate movement of the cart. The guide wheel is moveable into and between a first guide wheel position and a second guide wheel position, and when the guide wheel is in the first guide wheel position, the guide wheel resists movement of the cart in a direction other than in a longitudinal direction.

### CROSS-REFERENCE TO RELATED APPLICATION

The present disclosure is based on and claims priority to U.S. Provisional Patent Application No. 63/678,623 filed Aug. 2, 2024, the disclosure of which is incorporated herein by reference.

### FIELD

The present disclosure relates to carts and specifically to carts with guide wheels.

### BACKGROUND

The following U.S. patent application Publication is incorporated herein by reference in entirety.

U.S. Patent Application Publication No. 2021/0245789 discloses carts for transporting objects having a base and a first end wall and an opposite second end wall extending from the base. A sidewall extends from the base and between the end walls such that the base, the first end wall, the second end wall, and the sidewall define an interior space of the cart. A hinge couples a door to the first end wall such that the door can be pivoted into different positions.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a cart for transporting objects includes a frame longitudinally extending between a first end and a second end and a plurality of wheel assemblies and a guide wheel coupled to the frame. The plurality of wheel assemblies and the guide wheel are configured to facilitate movement of the cart. The guide wheel is moveable into and between a first guide wheel position and a second guide wheel position, and when the guide wheel is in the first guide wheel position, the guide wheel resists movement of the cart in a direction other than in a longitudinal direction.

In certain examples, a cart for transporting objects includes a frame longitudinally extending between a first end and a second end and laterally between a first side and a second side and a plurality of wheel assemblies and a guide wheel coupled to the frame. The plurality of wheel assemblies and the guide wheel are configured to facilitate movement of the cart, and the guide wheel is moveable into and between a first guide wheel position and a second guide wheel position. When the guide wheel is in the first guide wheel position, the guide wheel resists movement of the cart in a lateral direction, and when the guide wheel is in the second guide wheel position, the cart is movable in a lateral direction.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example cart according to the present disclosure.

FIG. 2 is another perspective view of the cart of FIG. 1.

FIG. 3 is an enlarged view of an example handle according to the present disclosure.

FIG. 4 is a side view of the handle of FIG. 3 in a first handle position.

FIG. 5 is a side view of the handle of FIG. 3 in a second handle position.

FIG. 6 is a perspective view of an example guide wheel assembly according to the present disclosure.

FIG. 7 is a side view of the guide wheel assembly of FIG. 6 with a guide wheel in a first guide wheel position.

FIG. 8 is a side view of the guide wheel assembly of FIG. 6 with the guide wheel in a second guide wheel position.

FIG. 9 is a perspective view of another example cart according to the present disclosure.

FIG. 10 is an enlarged view of an example handle depicted in FIG. 9.

FIG. 11 is a perspective view of an example guide wheel assembly depicted in FIG. 9.

FIG. 12 is a schematic side view of the guide wheel assembly of FIG. 9 with the wheel in the first guide wheel position.

FIG. 13 is a schematic side view of the guide wheel assembly of FIG. 9 with the wheel in the second guide wheel position.

### DETAILED DESCRIPTION

Employees use carts to collect and transport objects in facilities, such as warehouses, distribution centers, and commercial stores. Through research and experimentation, the present inventors have endeavored to develop carts that are easily maneuvered, controlled, and/or stopped especially when transporting objects. Accordingly, the present inventors invented the example carts described below.

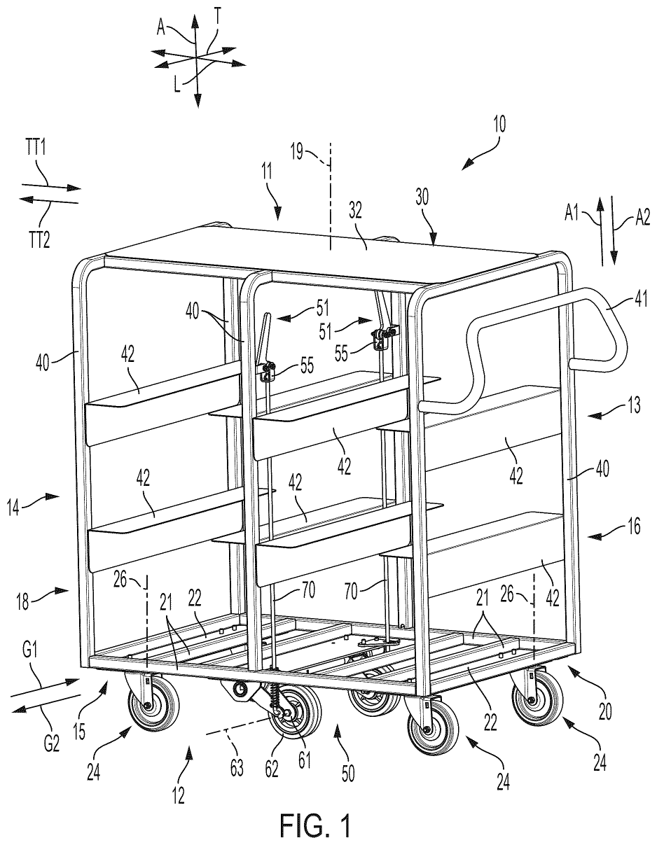

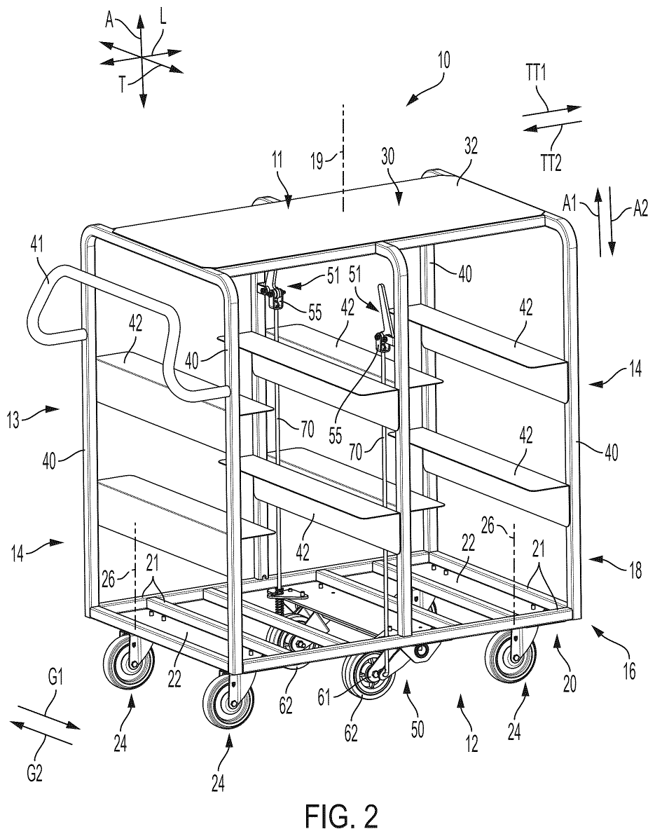

FIGS. 1-2 depict an example cart 10 of the present disclosure. The cart 10 has a frame 18 that that generally axially extends along a cart axis 19 (see also example vertical axis A) between a top 11 and a bottom 12, laterally extends (see example lateral axis T) between a first side 15 and an opposite second side 16, and longitudinally extends (see example longitudinal axis L) between a first end 13 and an opposite second end 14. The frame 18 includes a plurality of framing members 21 (e.g., metal square tubing) and a plurality of columns 40 (e.g., metal square tubing, metal angles).

The cart 10 also includes a base section 20 and a top section 30. The plurality of columns 40 extends between the base section 20 and the top section 30. A pair of base plates 22 are coupled to the framing members 21 at the base section 20. Objects (e.g., boxes, containers, parts) can be placed on the framing members 21 and/or the base plates 22.

A plurality of wheel assemblies 24 are coupled to the base plates 22, and the wheel assemblies 24 vertically support the cart 10 on a support surface (e.g., ground G, concrete floor). The wheel assemblies 24 also permit the operator of the cart 10 to move the cart 10 along the support surface. Each wheel assembly 24 includes a frame and a wheel, and each wheel assembly 24 is rotatable 360.0 degrees about a vertically extending wheel axis 26 such that the cart 10, in certain modes of operation (described further herein), can be moved (e.g., rotated, turned, spun) in any direction (e.g., moved in a travel direction TT) and rotated 360.0 degrees. In other examples, the plurality of wheel assemblies 24 are replaced with caster assemblies that include castors instead of wheels.

One or more framing members 21 at the top section 30 of the cart 10 support a top plate 32 such that objects (e.g., boxes, containers, parts) can be placed on the top plate 32. A handgrip 41, which is engaged by the operator when moving the cart 10, is coupled to the columns 40 at the first end 13. The columns 40 also support laterally extending hanger brackets 42 on which objects (e.g., containers with perimeter lips or flanges) are hung in the cart 10.

One or more handles 51 are coupled to the columns 40 and located axially below the top plate 32. As will be described in greater detail hereinbelow, the handles 51 can be operated by the operator to change the position of one or more guide wheels 62 of a guide wheel assembly 50 to thereby change the operational mode of the cart 10. Locating the handles 51 axially below the top plates 32 advantageously allows for objects on the top plate without the handle 51 obstructing the object and protects the handles 51 from damage. In other example carts 10, the handles 51 could be located at a different location on the cart 10 such as axially above the top plate 32 or at the base section 20. Note that in some other examples, the handles could be configured as foot pedals which could be operated by the foot of the operator while still functioning with the components of the example carts 10 described herein.

The number of handles 51 included with the cart 10 can vary, and in the example depicted in FIGS. 1-2, the cart 10 includes a pair of handles 51 with one handle 51 coupled to columns 40 on each side 15, 16 of the cart 10. Note that while the handle 51 below is described located at the first side 15, the other handle 51 is located at the second side 16 and this other handle can include any of the features and/or components described with reference to the handle 51 located at the first side 15. Further note that some of the features or movements of the handle 51 located at the second side 16 may be mirrored or reversed from the features or movements of the handle 51 located at the first side 15.

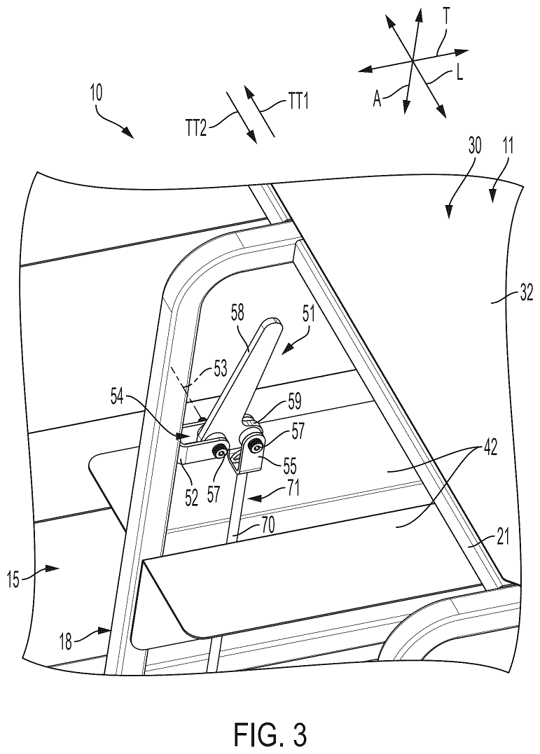

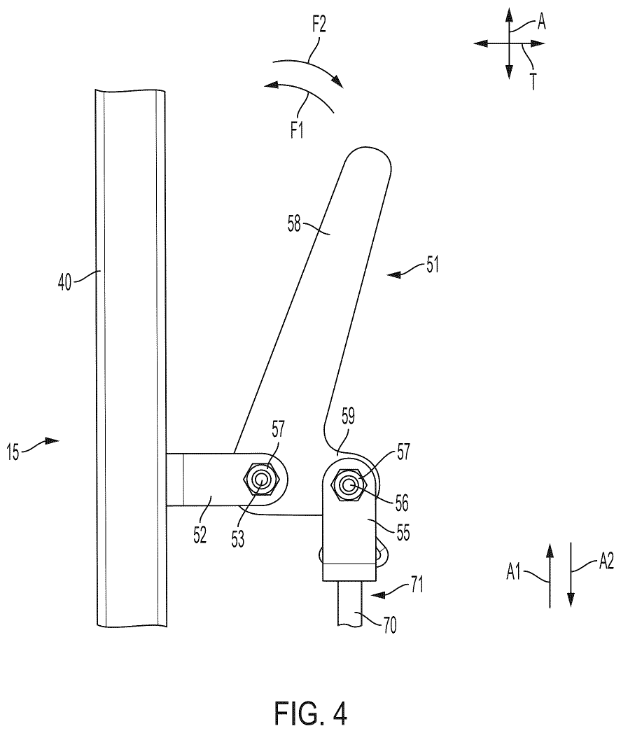

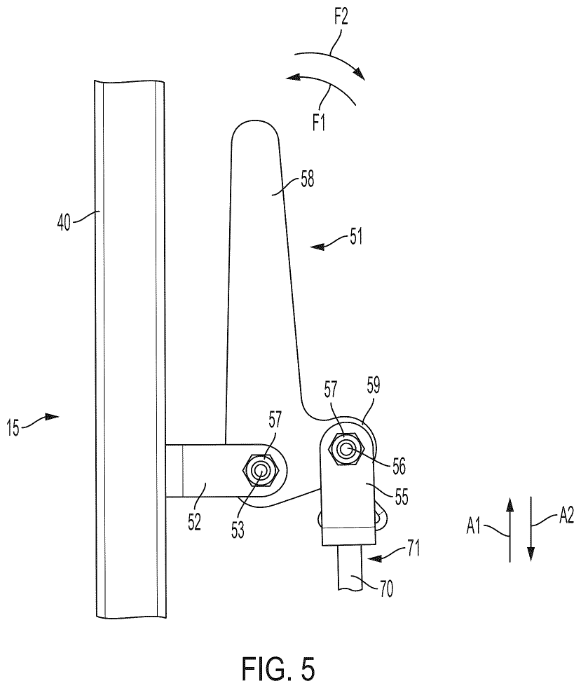

FIG. 3 depicts the handle 51 at the first side 15 and being coupled to the column 40 with a brace member 52. FIGS. 4-5 depict the handle 51 in greater detail and the handle 51 in different handle positions. Specifically, FIG. 4 depicts the handle 51 in a first handle position, and FIG. 2 depicts the handle 51 in a second handle position.

The handle 51 has an arm 58 and a leg 59. The handle 51 is generally L-shaped. The arm 58 is pivotably coupled to a brace member 52 via a fastener 57 (e.g., screw, bolt with nut), and the brace member 52 is fixedly coupled to the column 40. The handle 51 can be pivoted relative to the brace member 52 and about a handle axis 53. In certain examples, the brace member 52 is U-shaped. In certain examples, the brace member 52 is a U-shaped bracket that defines a channel 54.

The leg 59 is pivotably coupled to a yoke 55 via a fastener 57 (e.g., screw, bolt with nut). The leg 58 can be pivoted relative to the yoke 55 and about a yoke axis 56. In certain examples, the brace member 52 is U-shaped and/or includes a channel. The yoke 55 is coupled to an actuating member 70 (described further herein below).

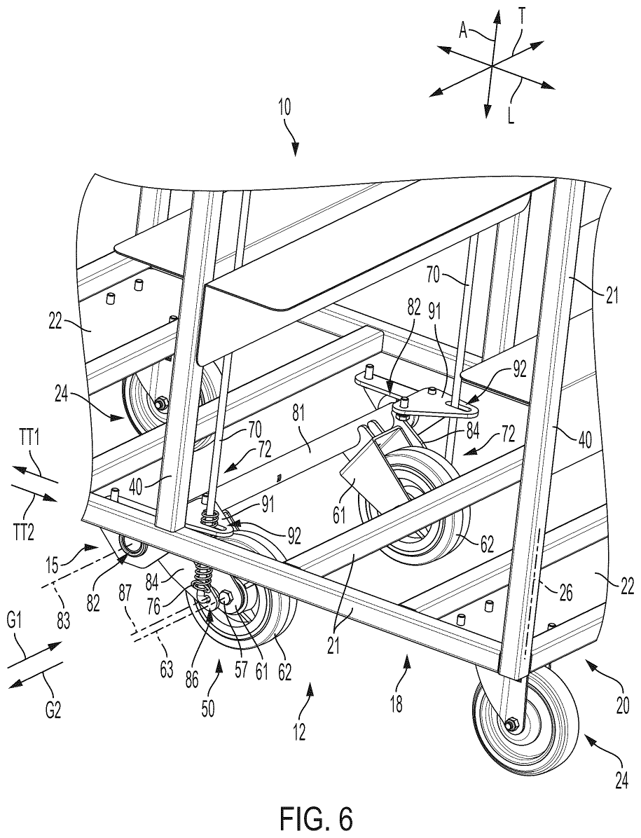

The actuating member 70 has a first end 71 coupled to the leg 59 of the handle 51 and an opposite second end 72 coupled to a guide wheel assembly 50 located at the base section 20 of the cart 10. In certain examples, the actuating member 70 extends along one of the columns 40. The actuating member 70 can be any suitable device such as a rod, cable, spring, and/or the like. The number of actuating members 70 that are coupled to the guide wheel assembly 50 can correspond to the number of handles 51. In the example depicted in FIG. 6, an actuating member 70 extends from each of the handles 51 such that two actuating members 70 are coupled to the guide wheel assembly 50.

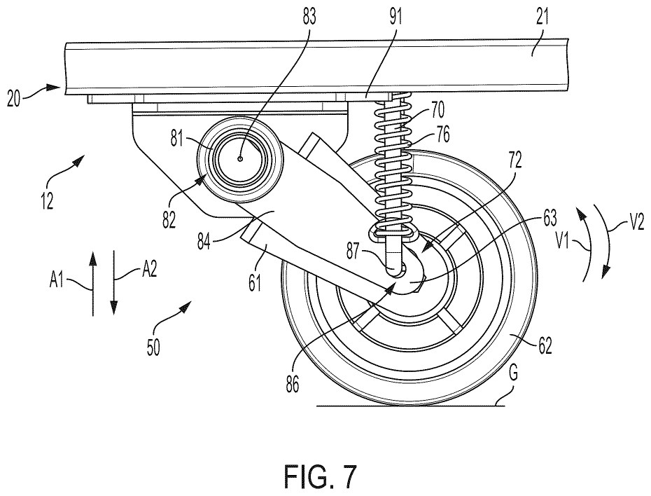

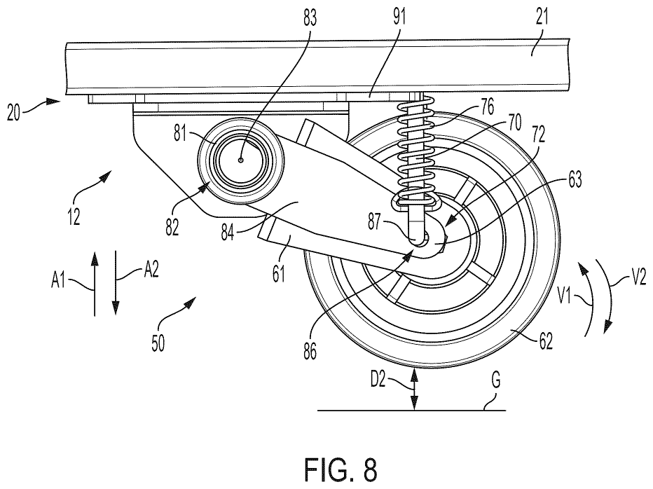

FIG. 6 depicts the guide wheel assembly 50 in greater detail, and FIGS. 7-8 schematically depicts the guide wheels 62 in different positions (described further herein below).

The guide wheel assembly 50 includes a pivot member 81 with pivot ends 82 pivotably secured to the framing member 21 of the base section 20. The pivot member 81 extends along a pivot axis 83. In certain examples, the pivot member 81 laterally extends along one of the framing members 21 at the base section 20.

The guide wheel assembly 50 includes one or more wheel frames 61 that are coupled to the pivot member 81 and radially extend from the pivot member 81 The wheel frames 61 rotate with the pivot member 81 about the pivot axis 83 (described further herein). A guide wheel 62 is coupled to each wheel frame 61 with a fastener 57. The guide wheels 62 can rotate about a wheel axis 63 and relative to the wheel frame 61. However, the guide wheel 62 cannot rotate about a longitudinally extending axis and the guide wheel 62 does not have 360 degrees of rotational freedom. In certain examples, the pivot axis 83 extends transverse to the handle axis 53 and the yoke axis 56 (FIG. 3). In certain examples, the wheel axis 63 extends parallel to the pivot axis 83. In certain examples, the guides wheels 62 are longitudinally located between the first end 13 and the second end 14.

The number of guide wheels 62 can vary. In the example depicted in FIG. 6, two guide wheels 62 are utilized. The present inventor recognized that utilizing two or more guide wheels 62 can advantageously improve the stability of the cart 10 (especially when moving the cart 10 over ramps or uneven surfaces), and/or increase the resistance of the cart 10 moving transverse (e.g., perpendicular) to a longitudinal direction TT1, TT2 of the cart 10 (described further herein). The present inventor also recognized that including multiple guide wheels 62 advantageously assures that at least one guide wheel 62 maintains contact with the ground over uneven terrain, and in some example, the guide wheels 62 could move independently over bumps or ramps but could still be moved to the second guide wheel position together.

The guide wheel assembly 50 also includes a pivot bracket 84 that is coupled to the pivot member 81 and radially extends from the pivot member 81. The pivot bracket 84 is coupled to the second end 72 of the actuating member 70. As will be described in greater detail hereinbelow, movement (e.g., rotation) of the pivot bracket 84 about the pivot axis 83 rotates the pivot member 81 about the pivot axis 83.

In the example depicted in FIG. 6, the second end 72 includes a hook that is received into a hole 86 defined in the pivot bracket 84. In other examples, the second end 72 is coupled to the pivot bracket 84 via a fastener. The second end 72 can pivot relative to the pivot bracket 84 via a bracket axis 87. In certain examples, the bracket axis 87 is offset from the wheel axis 63. In other examples, the bracket axis 87 is aligned with the wheel axis 63. The number of pivot brackets 84 can correspond to the number of actuating members 70. In certain examples, the pivot bracket 84 is located at or adjacent to the pivot ends 82.

In certain examples, a guide bracket 91 is coupled to the framing member 21 and includes a slot 92 in which the actuating member 70 is slidably received. The guide bracket 91 prevents bowing of the actuating member 70 during movement. In certain examples, a biasing member 76 extends along the actuating member 70 between the guide bracket 91 and the second end 72. The biasing member 76 is for acting on the guide wheel assembly 50 to thereby bias the guide wheels 62 into a first guide wheel position (described further herein). The biasing member 76 can be any suitable device such as a spring, hinge, gas cylinder, gas piston, and/or the like.

An example operational sequence for moving the cart 10 into and between a first operational mode and a second operational mode is described hereinbelow.

FIGS. 1-2 and 6 depict the cart 10 in the first operational mode in which the handles 51 are in a first handle position (see FIG. 4). The guide wheels 62 are in a first guide wheel position (see also FIG. 7) such that the wheels 62 engage a support surface (e.g., ground G). As noted above, the guide wheels 62 do not have 360 degrees of rotational freedom, and thus, as the cart 10 is moved by the operator while in the first operational mode, the guide wheels 62 resist movement of the cart 10 in a direction other than the movement in a longitudinal direction (see example first longitudinal direction TT1 and an opposite second longitudinal direction TT2 that the cart 10 can be moved). In one example, the first direction of travel TT1 represents the longitudinal direction that the operator moves the cart 10 when pushing the cart 10 forward. In another example, the guide wheels 62 resist orthogonal movement of the cart 10 relative to movement in a longitudinal direction (see example first longitudinal direction TT1 and second longitudinal direction TT2), resist rotation of the cart 10 relative to the cart axis 19, and/or prevent deviating movement of the cart 10 from a longitudinal direction. As such, the guide wheels 62 help the cart 10 track straight in a longitudinal direction and resist movement in other directions. In certain examples, the guide wheels 62 act as fixed wheels in the center of the cart 10 that resist and prevent the cart from moving transverse (e.g., perpendicular) to the direction of travel TT. The prevented transverse movement is sometimes known in the industry as ‘crabbing’. Note that absent the engagement of the guide wheels 62 with the ground G, in some examples the cart 10 may be difficult to move along a straight path, may inadvertently veer off course, and/or may be difficult for the operator to control.

In certain examples, the guide wheels 62 resisting movement of the cart 10 in directions other than a longitudinal direction does not inhibit the ability of the wheel assemblies 24 to rotate and move. In certain examples, the guide wheels 62 in the first wheel position provides traction for the cart 10 so that the cart 10 does not drift or skid when turning around the corner. In certain examples, while the guide wheels 62 in the first guide wheel position resist the movement note above, the cart 10 can be still be moved in directions other than a longitudinal direction and/or rotated however, such movement requires additional effort by the operator of the cart 10.

In the event that the operator desires to easily move the cart in a direction other than a longitudinal direction and/or more quickly rotate the cart or move the cart 10 in a direction orthogonal to the longitudinal direction (e.g., the operator wishes to spin the cart 10 around to access a different side of the cart 10; while the operator is turning a tight corner between shelving aisles), the operator moves from the cart 10 from the first operation mode to a second operation mode (described further herein).

To move the cart 10 to the second operational mode, the operator engages the handle 51 to thereby move the handle 51 from the first handle position (FIG. 4) to the second handle position (FIG. 5). When in the first handle position (FIG. 4), the arm 58 of the handle 51 extends transverse to the column 40 and the yoke 55 is in a lowered, first yoke position relative to the brace member 52. As the operator engages the arm 58 and applies a force in a first handle direction (see arrow F1), the arm 58 is pivoted about the handle axis 53 and the leg 59 is pivoted about the yoke axis 56. The arm 58 is moved in a direction toward the column 40, and the leg 59 and the yoke 55 are moved axially upwardly. As such, the handle 51 is in the second handle position (FIG. 5) and the yoke 55 is in a second yoke position axially above the yoke 55 in the first yoke position (see distance arrow D). The arm 58 is located closer to the column 40 in the second handle position (FIG. 5) than when the handle 51 is in the first handle position (FIG. 4). Note that in certain examples, the yoke 55 and/or the actuating member 70 can transversely move as the handle 51 is moved between the first handle position and the second handle position.

As the yoke 55 is axially moved from the first yoke position (FIG. 4) to the second yoke position (FIG. 5), the first end 71 of the actuating member 70 is axially moved (e.g., pulled) in a first axial direction A1 and the second end 72 is also moved in the first axial direction (see FIG. 8). The second end 72 acts on and moves (e.g., pivots) the pivot bracket 84 (see FIG. 8) in the first axial direction A1 and/or about the pivot axis 83 in a first rotational direction V1. The biasing member 76 is compressed between the guide bracket 91 and the second end 72.

The movement of the pivot bracket 84 causes the pivot member 81 to also rotate about the pivot axis 83 in the first rotational direction V1. As the pivot member 81 is rotated, the wheel frame 61 and the guide wheel 62 are also pivoted about the pivot axis 83 in the first rotational direction V1 and such that the guide wheels 62 is moved (e.g., axially lifted in the first axial direction A1 and rotated in the first rotational direction V1) off the off the ground G (see distance D2 representing the distance between the ground G and the guide wheel 62) into second guide wheel position (see FIG. 8). As such, the guide wheels 62 does not act on the ground G and the operator can more easily maneuver the cart 10 on the wheel assemblies 24, which as noted above, can include moving the cart 10 in directions other than a longitudinal direction and/or rotate the cart 10 about the cart axis 19. In certain examples, when the guide wheel 62 is in the second guide wheel position (described further herein), the cart 10 is movable in a first lateral direction G1 and a second lateral direction G2. In certain examples, a latch (not depicted) is included to lock the handle 51 in the second handle position.

Once the operator wishes to move the cart 10 in a more linear manner and/or again resist movement in a direction different than the longitudinal directions TT1, TT2, the operator releases the handle 51 such that the handle 51 is moved from the second handle position (FIG. 5) to the first handle position (FIG. 4) under force of gravity and/or decompression of the biasing member 76 and the guide wheels 62 are moved into engagement with the ground G (described further herein).

For example, the weight of the guide wheel 62 and the wheel frame 61 causes the pivot member 81 to be rotated in a second rotational direction V2 opposite the first rotational direction V1 and about the pivot axis 83. The rotation of the pivot member 81 also rotates the pivot bracket 84 in the second rotational direction V2, and pivot bracket 84 axially moves the actuating member 70 in a second axial direction A2 opposite the first axial direction A1. The actuating member 70 moves (e.g., pulls) the yoke 55 in the second axial direction V2 and the arm 58 and the leg 59 thereby pivot about the handle axis 53 and the yoke axis 56, respectively, and the handle 51 is moved in a second handle direction (see arrow F2) from the second handle position (FIG. 5) to the first handle position (FIG. 4). The guide wheels 62 are also in the first guide wheel position (FIG. 7), and thus, the cart 10 is back in the first operational mode (FIGS. 1-2 and 6).

In some examples, the biasing member 76 decompresses and applies forces to the second end 72 of the actuating member 70 in the second axial direction A2 such that the pivot bracket 84 is rotated in the second rotational direction V2. The pivot bracket 84 rotates the pivot member 81 about the second rotational direction V2, and the wheel frame 61 and the guide wheel 62 are rotated in the second rotational direction V2 with the pivot member 81. As such, the guide wheels 62 are moved into the first guide wheel position. The pivot bracket 84 also axially moves the actuating member 70 in the second axial direction A2, and the actuating member 70 moves the yoke 55 in the second axial direction V2. As such, the arm 58 and the leg 59 are pivoted about the handle axis 53 and the yoke axis 56, respectively, such that handle 51 is moved in a second handle direction (see arrow F2) to the first handle position (FIG. 4). The guide wheels 62 are each in the first guide wheel (FIG. 7) and the cart 10 is back in the first operational mode (FIGS. 1-2 and 6).

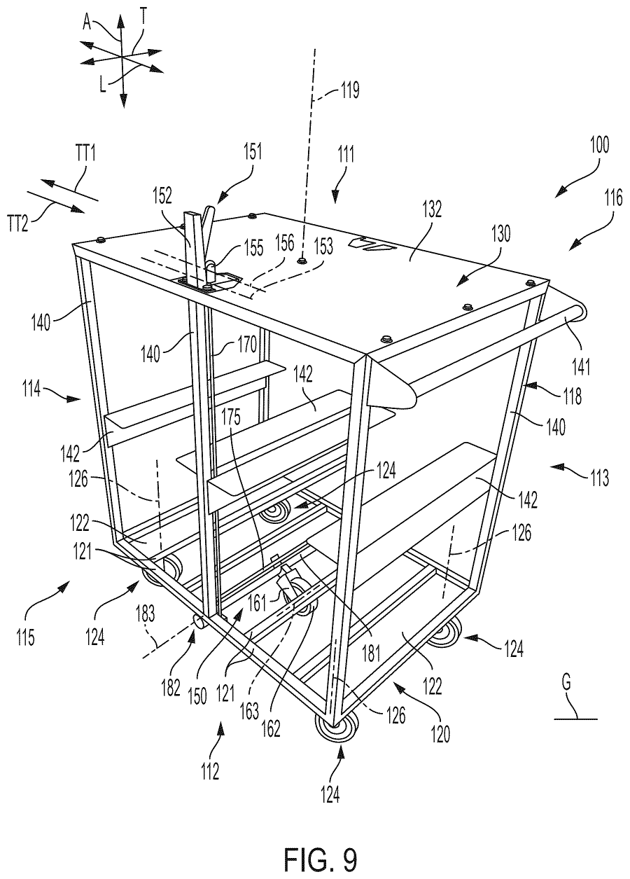

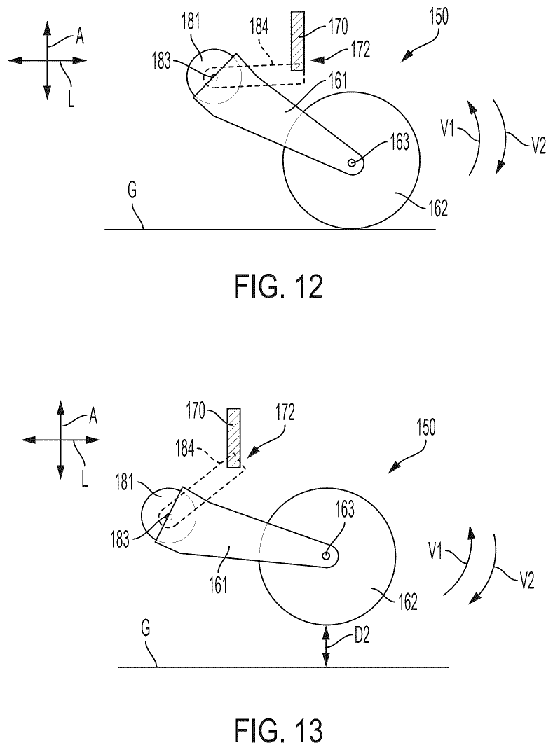

The example cart 100 depicted in FIGS. 9-13 can include one or more features (e.g., pivoting the wheels) and/or components (e.g., handles) described with reference to the other example carts 10 described above with respect to FIGS. 1-8. Similarly, the example carts 10 described with reference to FIGS. 1-8 can include any features and/or components described herein below with reference to the example cart 100 depicted in FIGS. 9-13. Note that some components of the example cart 100 described with reference to FIGS. 9-13 that are similar to the components of the example cart 10 described with reference to FIGS. 1-8 have similar names and/or denoted with the same part numbers, however, it should be understood that the use of the same part name and/or part numbers for features and/or components of the present disclosure should not be construed to indicate that the similarly described features and/or components are necessarily identical. Instead, the similarly named and/or marked features and/or components may have varying features or characteristics. For instance, the cart 10 depicted in FIG. 1 includes two handles 51 that are each L-shaped and the cart 100 depicted in FIG. 9 includes one handle 151 that is L-shaped.

The cart 100 has a frame 118, a base section 120, and a top section 130. The frame 118 includes a plurality of framing members 121 and a plurality of columns 140. A pair of base plates 122 are coupled to the framing members 121 at the base section 120. Objects (e.g., boxes, containers, parts) can be placed on the framing members 121 and/or the base plates 122.

One or more wheel assemblies 124 are coupled to the base plates 122, and the wheel assemblies 124 vertically support the cart 100 on the support surface. Each wheel assembly 124 includes a frame and a wheel, and each wheel assembly 124 is rotatable 360.0 degrees about a vertically extending wheel axis 126 such that the cart 110 can be rotated about a cart axis 119 on the wheel assemblies 124. In other examples, the plurality of wheel assemblies 124 are replaced with caster assemblies that include castors instead of wheels.

The top section 130 of the cart 100 includes one or more framing members 121 that support a top plate 132. The plurality of columns 140 axially extend between the framing member 121 of the top section 130 and the framing members 121 of the base section 120. A handgrip 141, which is engaged by the operator when moving the cart 100, is coupled to the columns 140 at the first end 113. The columns 140 laterally support hanger brackets 142 on which objects (e.g., containers with perimeter lips or flanges) are hung in the cart 100. A handle 151 is coupled to the top 111 and located axially above the top plate 132.

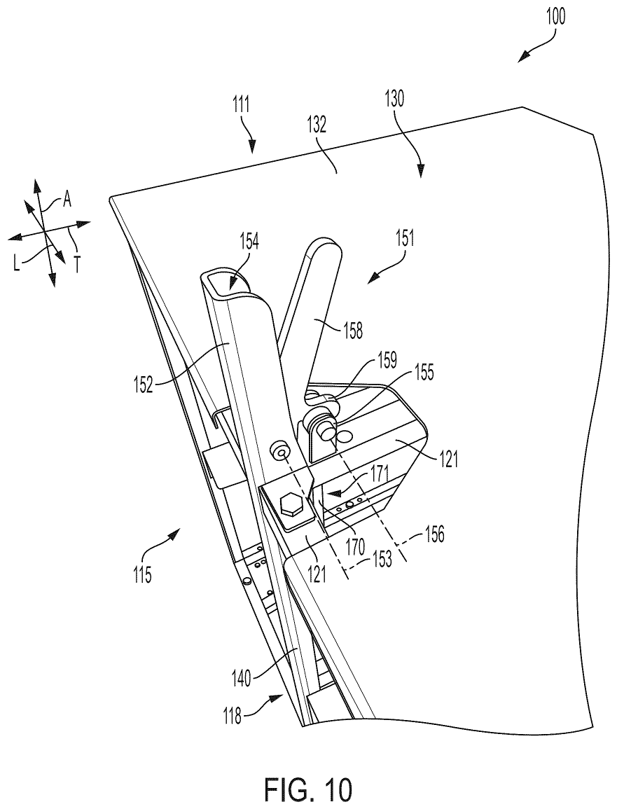

Referring to FIG. 10, the handle 51 is coupled to a framing member 121 via a brace member 152. The handle 51 is movable into a first handle position and a second handle position. The handle 51 has an arm 158 and a leg 159. The handle 51 generally is L-shaped. The arm 58 is pivotably coupled to the brace member 152. The handle 151 can be pivoted relative to the brace member 152 and about a handle axis 53. In certain examples, the brace member 152 is U-shaped. In certain examples, the brace member 152 is a U-shaped bracket that defines a channel 154.

The leg 159 is pivotably coupled to a yoke 155. The leg 159 can be pivoted relative to the yoke 155 and about a yoke axis 156. The yoke 155 is coupled to an actuating member 170 (described further herein below). Specifically, the actuating member 170 has a first end 171 coupled to the leg 159 and an opposite second end 172 coupled to a guide wheel assembly 150 located at the base section 120 of the cart 100.

The guide wheel assembly 150 includes a pivot member 181 with pivot ends 182 pivotably secured to the framing member 121 of the base section 120. The pivot member 181 extends along a pivot axis 183. In certain examples, an alignment member 175 extends parallel to the pivot member 181 and is for supporting and/or stiffening the pivot member 181. The alignment member 175 can also aid in the construction of the cart 10 and/or help to maintain alignment of the components of the guide wheel assembly 150.

The guide wheel assembly 150 includes a wheel frame 161 that is coupled to the pivot member 181 and extends radially from the pivot member 81. The wheel frame 161 rotates with the pivot member 181 about the pivot axis 183 (described further herein). A guide wheel 162 is coupled to the wheel frame 161. The guide wheel 162 can rotate about a wheel axis 163 and relative to the wheel frame 161. However, the guide wheel 162 cannot rotate about a longitudinally extending axis, and the guide wheel 162 does not have 360 degrees of rotational freedom.

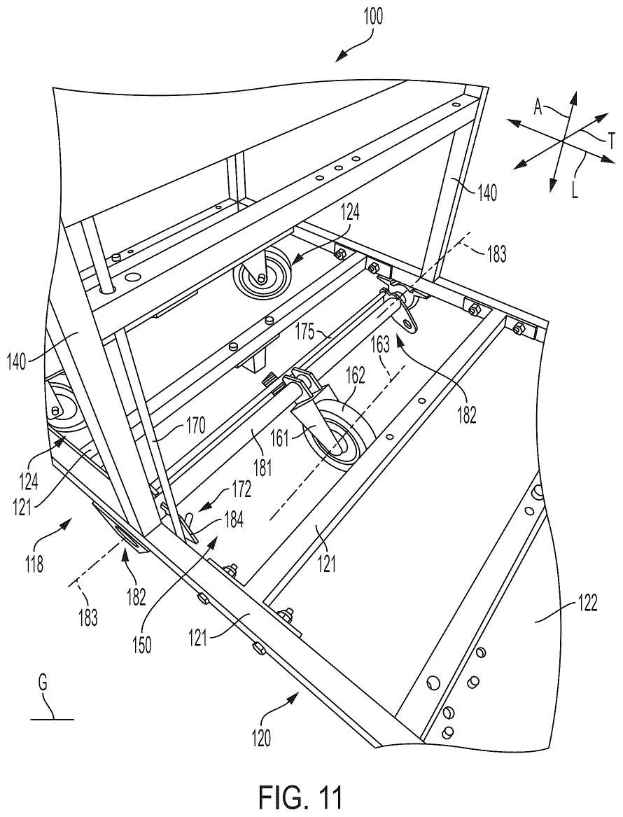

The guide wheel assembly 150 also includes a pivot bracket 184 that is coupled to the pivot member 181 and radially extends from the pivot member 181. The pivot bracket 184 is coupled to the second end 172 of the actuating member 170. As will be described in greater detail hereinbelow, movement (e.g., rotation) of the pivot bracket 184 about the pivot axis 183 rotates the pivot member 181 about the pivot axis 183. In the example depicted in FIG. 11, the second end 172 includes a hook that is received into a hole 186 defined in the pivot bracket 184.

FIGS. 9-12 depict the cart 100 in the first operational mode in which the handle 51 is the first handle position and the guide wheel 162 is in the first guide wheel position such that the guide wheel 162 engages the ground G.

To move the cart 100 to the second operational mode, the operator engages the handle 151 and moves the handle 151 from the first handle position to the second handle position such that the yoke 155 is moved from the first yoke position to the second yoke position. The first end 171 of the actuating member 170 is axially moved (e.g., pulled) in the first axial direction A1, and the second end 172 is also moved in the first axial direction A1. The second end 172 acts on and moves (e.g., pivots) the pivot bracket 184 in the first axial direction A1 and/or about the pivot axis 183 in a first rotational direction V1.

The movement of the pivot bracket 184 causes the pivot member 181 to also rotate about the pivot axis 183 in the first rotational direction V1. As the pivot member 81 is rotated, the wheel frame 161 and the guide wheel 162 are pivoted with the pivot member 181 about the pivot axis 183 in the first rotational direction V1 and such that the guide wheels 162 is moved (e.g., axially lifted in the first axial direction A1 and rotated in the first rotational direction V1) off the off the ground G (see FIG. 13). As such, the guide wheels 162 does not act on the ground G and cart 100 is in the second operational mode in which the cart 100 can be moved more easily in directions other than the longitudinal directions TT1, TT2.

To move the cart 100 back to the first operational mode, the operator releases the handle 5. The handle 51 is moved from the first handle position to the second handle position under the force of gravity. For example, the weight of the guide wheel 162 and the wheel frame 161 causes the pivot member 181 to be rotated in a second rotational direction V2 opposite the first rotational direction V1 and about the pivot axis 183. The guide wheel 162 is in the first guide wheel position and engages the ground G. The rotation of the pivot member 181 also rotates the pivot bracket 84 in the second rotational direction V2, and pivot bracket 184 axially moves the actuating member 170 in a second axial direction A2 opposite the first axial direction A1. The actuating member 170 moves the yoke 155 in the second axial direction V2 and the arm 158 and the leg 159 pivot about the handle axis 153 and the yoke axis 156, respectively, such that the handle 51 is moved to the first handle position. As such, the cart 100 is back in the first operational mode, and the guide wheel 162 resist movement of the cart 100 in a direction other than the movement in a longitudinal direction TT1, TT2.

In certain examples, a cart for transporting objects includes a frame longitudinally extending between a first end and a second end and a plurality of wheel assemblies and a guide wheel coupled to the frame. The plurality of wheel assemblies and the guide wheel are configured to facilitate movement of the cart. The guide wheel is moveable into and between a first guide wheel position and a second guide wheel position, and when the guide wheel is in the first guide wheel position, the guide wheel resists movement of the cart in a direction other than in a longitudinal direction.

In independent aspects, the frame axially extends between a top and a bottom along a cart axis and laterally extends in between a first side and a second side, and when the guide wheel is in the first guide wheel position, the guide wheel resist rotation of the cart about the cart axis and/or movement of the cart in a lateral direction. In independent aspects, when the guide wheel is in the first guide wheel position the guide wheel is configured to engage a support surface, and when the guide wheel is in the second guide wheel position, the guide wheel is configured to be spaced apart from the support surface. In independent aspects, a pivot member extends along a pivot axis and the guide wheel is coupled to the pivot member such that rotation of the pivot member about the pivot axis in a first rotational direction moves the guide wheel in a direction from the first guide wheel position toward the second guide wheel position and rotation of the pivot member about the pivot axis in a second rotational direction moves the guide wheel in a direction from the second guide wheel position to the first guide wheel position. In independent aspects, a pivot bracket is coupled pivot member and extends radially therefrom, and the pivot bracket is moved to thereby rotate the pivot member about the pivot axis in the first rotational direction or the second rotational direction. In independent aspects, an actuating member is coupled to the pivot bracket, and the actuating member is axially moved to thereby move the pivot bracket. In independent aspects, the actuating member is moved in a first axial direction to thereby pivot the pivot bracket and the pivot member in the first rotational direction and the actuating member is moved in a second axial direction to thereby pivot the pivot bracket and the pivot member in the second rotational direction. In independent aspects, a handle is coupled to the frame that is movable to thereby axially move the actuating member in the first axial direction and the second axial direction. In independent aspects, the actuating member is a rod. In independent aspects, the guide wheel is a guide wheel in a pair of guide wheels that are movable into and between the first guide wheel position and the second guide wheel position. In independent aspects, the guide wheel is located between the first end and the second end. In independent aspects, a handle is coupled to the frame and movable to thereby move the guide wheel into and between the first guide wheel position and the second guide wheel position. In independent aspects, the handle is pivotably coupled to the frame at a handle axis and the handle is pivoted about the handle axis in a first handle direction to thereby move the guide wheel from the first guide wheel position to the second guide wheel position and in a second handle direction to thereby move the guide wheel from the second guide wheel position to the first guide wheel position. In independent aspects, a biasing member biases the guide wheel to the first guide wheel position.

In independent aspects, a pivot member extends along a pivot axis and is coupled to the frame. The guide wheel is coupled to the pivot member, a pivot bracket is coupled to the pivot member, and an actuating member is coupled to and extending between the handle and the pivot bracket. The handle is movable from a first handle position to a second handle position to thereby axially move the actuating member in a first axial direction, and as the actuating member is moved in the first axial direction, the actuating member moves the pivot bracket such that the pivot member and the guide wheel are moved in a first rotational direction about the pivot axis and the guide wheel is moved from the first guide wheel position to the second guide wheel position.

In independent aspects, the handle is movable from the second handle position to the first handle position to thereby axially move the actuating member in a second axial direction, and as the actuating member is moved in the second axial direction, the actuating member moves the pivot bracket such that the pivot member and the guide wheel are moved in a second rotational direction about the pivot axis and the guide wheel is moved from the second guide wheel position to the first guide wheel position.

In independent aspects, when the handle is released from the second handle position, the actuating member is moved in a second axial direction and the pivot bracket, the pivot member, and the guide wheel are moved in a second rotational direction about the pivot axis under force of gravity such that the guide wheel is moved to the first guide wheel position.

In certain examples, a cart for transporting objects includes a frame longitudinally extending between a first end and a second end and laterally between a first side and a second side and a plurality of wheel assemblies and a guide wheel coupled to the frame. The plurality of wheel assemblies and the guide wheel are configured to facilitate movement of the cart, and the guide wheel is moveable into and between a first guide wheel position and a second guide wheel position. When the guide wheel is in the first guide wheel position, the guide wheel resists movement of the cart in a lateral direction, and when the guide wheel is in the second guide wheel position, the cart is movable in a lateral direction.

In independent aspects, the frame axially extends between a top and a bottom along a cart axis and when the guide wheel is in the first guide wheel position, the guide wheel resist rotation of the cart about the cart axis. In independent aspects, when the guide wheel is in the first guide wheel position the guide wheel is configured to engage a support surface and when the guide wheel is in the second guide wheel position, the guide wheel is configured to be spaced apart from the support surface.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cart for transporting objects, the cart comprising:
a frame longitudinally extending between a first end and a second end; and
a plurality of wheel assemblies and a guide wheel coupled to the frame;
wherein the plurality of wheel assemblies and the guide wheel are configured to facilitate movement of the cart; and
wherein the guide wheel is moveable into and between a first guide wheel position and a second guide wheel position, and wherein when the guide wheel is in the first guide wheel position, the guide wheel resists movement of the cart in a direction other than in a longitudinal direction.

2. The cart according to claim 1, wherein the frame axially extends between a top and a bottom along a cart axis and laterally extends in between a first side and a second side; and
wherein when the guide wheel is in the first guide wheel position, the guide wheel resists rotation of the cart about the cart axis and/or movement of the cart in a lateral direction.

3. The cart according to claim 1, wherein when the guide wheel is in the first guide wheel position the guide wheel is configured to engage a support surface; and
wherein when the guide wheel is in the second guide wheel position, the guide wheel is configured to be spaced apart from the support surface.

4. The cart according to claim 1, further comprising a pivot member extending along a pivot axis; and
wherein the guide wheel is coupled to the pivot member such that:
rotation of the pivot member about the pivot axis in a first rotational direction moves the guide wheel in a direction from the first guide wheel position toward the second guide wheel position; and
rotation of the pivot member about the pivot axis in a second rotational direction moves the guide wheel in a direction from the second guide wheel position to the first guide wheel position.

5. The cart according to claim 4, further comprising a pivot bracket coupled pivot member and extending radially therefrom, and wherein the pivot bracket is moved to thereby rotate the pivot member about the pivot axis in the first rotational direction or the second rotational direction.

6. The cart according to claim 5, further comprising an actuating member coupled to the pivot bracket, and wherein the actuating member is axially moved to thereby move the pivot bracket.

7. The cart according to claim 6, wherein the actuating member is moved in a first axial direction to thereby pivot the pivot bracket and the pivot member in the first rotational direction; and wherein the actuating member is moved in a second axial direction to thereby pivot the pivot bracket and the pivot member in the second rotational direction.

8. The cart according to claim 7, further comprising a handle coupled to the frame that is movable to thereby axially move the actuating member in the first axial direction and the second axial direction.

9. The cart according to claim 6, wherein the actuating member is a rod.

10. The cart according to claim 1, wherein the guide wheel is a guide wheel in a pair of guide wheels that are movable into and between the first guide wheel position and the second guide wheel position.

11. The cart according to claim 1, wherein the guide wheel is located between the first end and the second end.

12. The cart according to claim 1, further comprising a handle coupled to the frame and movable to thereby move the guide wheel into and between the first guide wheel position and the second guide wheel position.

13. The cart according to claim 12, wherein the handle is pivotably coupled to the frame at a handle axis, and wherein the handle is pivoted about the handle axis in a first handle direction to thereby move the guide wheel from the first guide wheel position to the second guide wheel position and in a second handle direction to thereby move the guide wheel from the second guide wheel position to the first guide wheel position.

14. The cart according to claim 13, further comprising a biasing member that biases the guide wheel to the first guide wheel position.

15. The cart according to claim 12, further comprising:
a pivot member extending along a pivot axis and coupled to the frame, wherein the guide wheel is coupled to the pivot member;
a pivot bracket coupled to the pivot member; and
an actuating member coupled to and extending between the handle and the pivot bracket;
wherein the handle is movable from a first handle position to a second handle position to thereby axially move the actuating member in a first axial direction; and
wherein as the actuating member is moved in the first axial direction, the actuating member moves the pivot bracket such that the pivot member and the guide wheel are moved in a first rotational direction about the pivot axis and the guide wheel is moved from the first guide wheel position to the second guide wheel position.

16. The cart according to claim 15, wherein the handle is movable from the second handle position to the first handle position to thereby axially move the actuating member in a second axial direction;
wherein as the actuating member is moved in the second axial direction, the actuating member moves the pivot bracket such that the pivot member and the guide wheel are moved in a second rotational direction about the pivot axis and the guide wheel is moved from the second guide wheel position to the first guide wheel position.

17. The cart according to claim 15, wherein when the handle is released from the second handle position, the actuating member is moved in a second axial direction and the pivot bracket, the pivot member, and the guide wheel are moved in a second rotational direction about the pivot axis under force of gravity such that the guide wheel is moved to the first guide wheel position.

18. A cart for transporting objects, the cart comprising:
a frame longitudinally extending between a first end and a second end and laterally between a first side and a second side; and
a plurality of wheel assemblies and a guide wheel coupled to the frame;
wherein the plurality of wheel assemblies and the guide wheel are configured to facilitate movement of the cart;
wherein the guide wheel is moveable into and between a first guide wheel position and a second guide wheel position, when the guide wheel is in the first guide wheel position, the guide wheel resists movement of the cart in a lateral direction and when the guide wheel is in the second guide wheel position, the cart is movable in a lateral direction.

19. The cart according to claim 18, wherein the frame axially extends between a top and a bottom along a cart axis; and
wherein when the guide wheel is in the first guide wheel position, the guide wheel resists rotation of the cart about the cart axis.

20. The cart according to claim 18, wherein when the guide wheel is in the first guide wheel position the guide wheel is configured to engage a support surface; and
wherein when the guide wheel is in the second guide wheel position, the guide wheel is configured to be spaced apart from the support surface.
